(19) United States
(12) Patent Application Publication
(10) Pub. No.: US 2023/0237307 A1
(43) Pub. Date: Jul. 27, 2023

(54) SYSTEMS AND METHODS FOR A HARDWARE NEURAL NETWORK ENGINE

(71) Applicant: InnoGrit Corporation, San Jose, CA (US)

(72) Inventors: Yan-Ruey Hsu, Zhubei (TW); Yuan-Mao Chang, Hsinchu (TW); Wan-Ru Lin, New Taipei City (TW)

(21) Appl. No.: 17/583,296

(22) Filed: Jan. 25, 2022

(51) Int. Cl. G06N 3/04

(52) U.S. Cl. CPC G06N 3/04

(57) ABSTRACT

Systems, apparatus and methods are provided for performing computations of a neural network using hardware computational circuitry. An apparatus may include a controller, a configuration buffer and a data buffer. The controller may be configured to dispatch computing tasks of a neural network, load configurations into the configuration buffer and load input data and parameters including weights and biases into the data buffer. The apparatus may also include a multiply-accumulate (MAC) layer. The configurations may include at least one FNN configuration. The MAC layer may apply the at least one FNN configuration, which includes settings for a FNN operation topology for the MAC layer to perform computations for at least one FNN layer. Optionally, the neural network may be a CNN and the configurations may further include at least one CNN configuration for the MAC layer to perform computations for at least one CNN layer.

### TECHNICAL FIELD

The disclosure herein relates to performing neural network computations using specialized hardware, particularly relates to performing neural network computations using configurable computational layers.

### BACKGROUND

Huge amount of data is generated in a lot of computing related fields. Before the recent achievement in machine leaning techniques, it is hard to make use of the data. With the development of machine learning techniques, however, data is harvested and mined to enhance product performance and add additional value. For example, in edge computing, machine learning has been used in data clustering and image recognition; and in solid state drives (SSD), machine learning has been used for hot-cold determination and NAND failure prediction.

Conventional machine learning systems were built using general purpose central processing units (CPUs). Later on, graphics processing units (GPUs) have been widely adopted for building machine learning systems. More recently, hardware artificial intelligent (AI) engines have emerged. Deep learning network operations, however, rely heavily on matrix multiplications, which include a huge amount of multiply-accumulate (MAC) operations. But on a system-on-a-chip (SoC) chip, space is limited for placing a large amount of hardware components for performing MAC operations. Moreover, current open-sourced AI engines is not compatible with particular needs in various fields. Therefore, there is a need for a configurable hardware implementation of AI neural networks.

### SUMMARY

The disclosed subject matter relates to systems, methods, and devices that may perform computations for a neural network using hardware computational circuitry. In an exemplary embodiment, there is provided an apparatus that may comprise a controller, a configuration buffer, a data buffer and a plurality of computational layers including a multiply-accumulate (MAC) layer that includes a plurality of MAC units. The controller may be configured to dispatch computing tasks of a neural network and configured to: load configurations for the plurality of computational layers to perform computations for the neural network into the configuration buffer, load parameters for the neural network into the data buffer and load input data into the data buffer. The configurations may include at least one fully-connected neural network (FNN) configuration for the MAC layer to perform computations for at least one FNN layer. The parameters may include weights and biases for the plurality of computational layers. The MAC layer may be configured to apply the at least one FNN configuration to perform the computations for the at least one FNN layer. The at least one FNN configuration may include settings for a FNN operation topology for the plurality of MAC units to perform the computations for the at least one FNN layer.

In some embodiments, the neural network may be a convolutional neural network and the configurations may further include at least one convolutional neural network (CNN) configuration for the MAC layer to perform computations for at least one CNN layer. The at least one CNN configuration may include settings for a CNN operation topology and settings for cycle-by-cycle operations for the plurality of MAC units to perform the computations for the at least one CNN layer. The settings for the CNN operation topology may include settings for operations in a row direction of an input data matrix, settings for operations in a column direction of the input data matrix, settings for operations in a row direction of a weight matrix and settings for operations in a column direction of the weight matrix.

In another exemplary embodiment, there is provided a method comprising: loading configurations for computational layers to perform computations for a neural network into a configuration buffer, loading parameters for the neural network into a data buffer, loading input data into the data buffer and activating the computational layers and applying the configurations to perform the computations for the neural network. The computational layers may include a multiply-accumulate (MAC) layer. The configurations may include at least one fully-connected neural network (FNN) configuration for the MAC layer to perform computations for at least one FNN layer. The parameters may include weights and biases for the computational layers. Activating the computational layers and applying the configurations may include applying the at least one FNN configuration to the MAC layer. The MAC layer may include a plurality of MAC units to perform the computations for the at least one FNN layer. The at least one FNN configuration may include settings for a FNN operation topology for the plurality of MAC units to perform the computations for the at least one FNN layer.

### BRIEF DESCRIPTION OF FIGURES

FIG. 1 schematically shows a computing system in accordance with an embodiment of the present disclosure.

FIG. 2 schematically shows a K-Means layer in accordance with an embodiment of the present disclosure.

FIG. 3 schematically shows a K-Means configuration for the K-Means layer in accordance with an embodiment of the present disclosure.

FIG. 4 schematically shows a MAC layer in accordance with an embodiment of the present disclosure.

FIG. 5A schematically shows a CNN configuration for the MAC layer to perform operations of a convolution layer in accordance with an embodiment of the present disclosure.

FIG. 5B schematically shows a data input matrix and a kernel for a convolutional neural network layer in accordance with an embodiment of the present disclosure.

FIG. 6 schematically shows a FNN configuration for the MAC layer to perform operations of a fully-connected layer in accordance with an embodiment of the present disclosure.

FIG. 7 schematically shows a quantization layer in accordance with an embodiment of the present disclosure.

FIG. 8 schematically shows a quantization configuration for the quantization layer in accordance with an embodiment of the present disclosure.

FIG. 9A schematically shows a lookup table layer in accordance with an embodiment of the present disclosure.

FIG. 9B schematically shows an activation function in accordance with an embodiment of the present disclosure.

FIG. 9C schematically shows an interpolation in accordance with an embodiment of the present disclosure.

FIG. 10 schematically shows a LUT configuration for the lookup table layer in accordance with an embodiment of the present disclosure.

FIG. 11 schematically shows a pooling layer in accordance with an embodiment of the present disclosure.

FIG. 12 schematically shows a pooling configuration for the pooling layer in accordance with an embodiment of the present disclosure.

FIG. 13 schematically shows a neural network in accordance with an embodiment of the present disclosure.

FIG. 14 is a flowchart of a process for performing computations of a neural network in accordance with an embodiment of the present disclosure.

### DETAILED DESCRIPTION

Specific embodiments according to the present disclosure will now be described in detail with reference to the accompanying figures. Like elements in the various figures are denoted by like reference numerals for consistency.

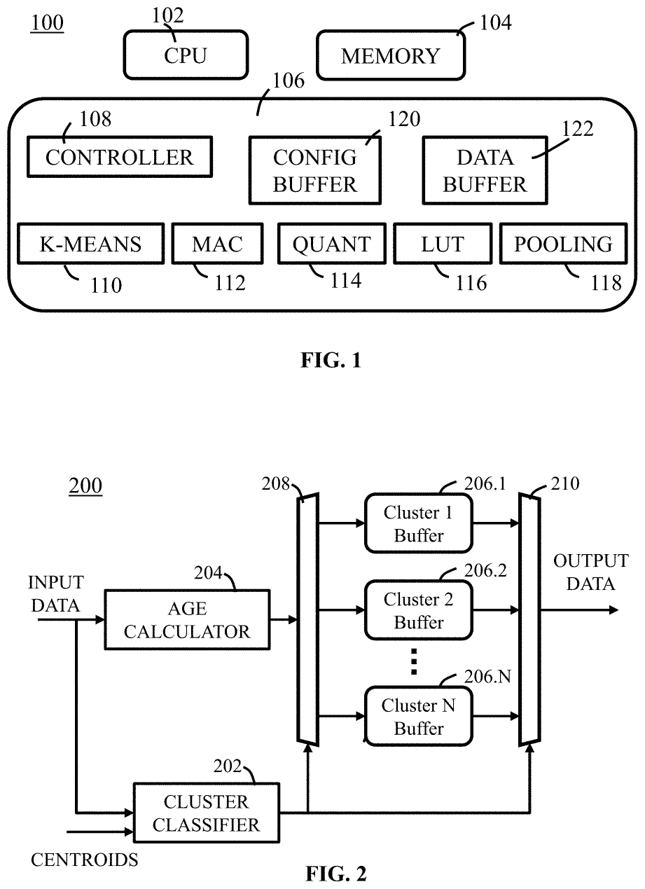

FIG. 1 schematically shows an exemplary computing system 100 according to an embodiment. The computing system 100 may comprise a central processing unit (CPU) 102, a memory 104 and an artificial intelligent (AI) engine 106. The CPU 102 may generate computing tasks for the AI engine 106 to perform. The memory 104 may be a temporary storage (e.g., dynamic random-access memory (DRAM) or static random-access memory (SRAM)) to store configurations and data for the CPU 102 and AI engine 106. It should be noted that, in some embodiments, the computing system 100 may include a plurality of CPUs and the CPU 102 may be just one representative of the plurality of CPUs.

The AI engine 106 may comprise a controller 108, and a plurality of hardware component layers including: a K-Means layer 110, a multiply-accumulate (MAC) layer 112, a quantization layer 114, a look up table (LUT) layer 116, a pooling layer 118. The hardware component layers may also be referred to as computational layers. The controller 108 may be configured to dispatch computing tasks to the various layers of the AI engine 106. The AI engine 106 may further comprise a configuration buffer 120 and a data buffer 122. The configuration buffer 120 may store configurations for the various layers and the data buffer 122 may store data for the computing tasks.

In at least one embodiment, weights, bias and quantization factors may be generated from a pre-trained neural network and stored in the memory 104. At run time, to perform a machine learning task, weights, bias and quantization factors for the layers may be loaded and stored in the data buffer 120. In some embodiments, the controller 108 may be a computer processor configured to execute executable instructions (e.g., software or firmware). In various embodiments, the controller 108 may be a microprocessor, a microcontroller, a field-programmable gate array (FPGA), or an application-specific IC (ASIC) or a Graphic Processing Unit (GPU).

The AI engine 106 may use the K-Means layer 110, MAC layer 112, quantization layer 114, look up table (LUT) layer 116, and the pooling layer 118 to perform computing tasks based on machine learning models. These layers may be implemented by hardware circuits and hardware configurations (also may be referred to as schedulers) may be generated for each of the K-Means layer 110, MAC layer 112, quantization layer 114, look up table (LUT) layer 116, and the pooling layer 118. A configuration may be a control sequence that includes one or more fields to describe the behavior of a computational layer and each computational layer may have its own scheduler. In one configuration, some rows may specify settings for repeated operations (e.g., looping). In some configurations, in addition to settings for looping, there may be additional rows that specify settings for cycle-by-cycle operation. The configurations may be pre-compiled based on the network architecture and function demand. At run time, the configurations may be fetched into the configuration buffer 120 by the controller 108. If the network architecture or function is changed, configurations may be updated correspondingly. Therefore, the AI engine 106 may support machine learning networks with different topology by the configurations defined for each computational layer.

For example, for one computational layer, the configurations may have the same format for different networks but with different field values. In some embodiments, a 32-bit configuration row format may be adopted to described the hardware behavior. It should be noted that the bit width for a configuration row may be flexible and modified for different hardware concerns. Different configurations may be applied to one computational layer at different stages of a neural network computation process so that the computational layer may be re-used for different computation tasks.

In one embodiment, as an example, the computing system 100 may be implemented on a storage controller of a solid state drive (SSD) and the SSD may be coupled to a host computing system. The host may perform a variety of data processing tasks and data access operations using a logical block address (LBA) to specify the location of blocks of data stored on the data storage devices of the SSD. LBA may be a linear addressing scheme in which blocks may be located by an integer index, for example, the first block being LBA 0, the second LBA 1, and so on. When the host wants to read or write data to the SSD, the host may issue a read or write command with an LBA and a length to the SSD. A machine learning model may be built to predict whether data associated with a data access command is hot or cold, which may be referred to as hot/cold prediction or hot/cold data determination. The machine learning model may be a neural network that may include many network layers. The K-Means layer 110, MAC layer 112, quantization layer 114, look up table (LUT) layer 116, and the pooling layer 118 may be configured to perform computation tasks assigned to the layers of the neural network according to respective configurations for each layer.

In the embodiments that the computing system 100 may be used for hot/cold data determination, data stored in the SSD may be categorized as hot or cold according to access characteristics. For example, data stored at a certain LBA may be hot data when the host (e.g., the operating system (OS) of the host computing system) frequently access that data; and data stored at a certain LBA may be cold data when the host (e.g., the operating system (OS) of the host computing system) seldomly access that data. Hot/cold data determination may be used to improved efficiency and lifetime of SSDs, such as, but not limited to, garbage collection, overprovisioning, wear leveling, storing hot or cold data to different types of NVMs (e.g., hot data to fast NAND such as Single-Level Cell (SLC) and cold data to slow NAND such as Quad-Level Cell (QLC)).

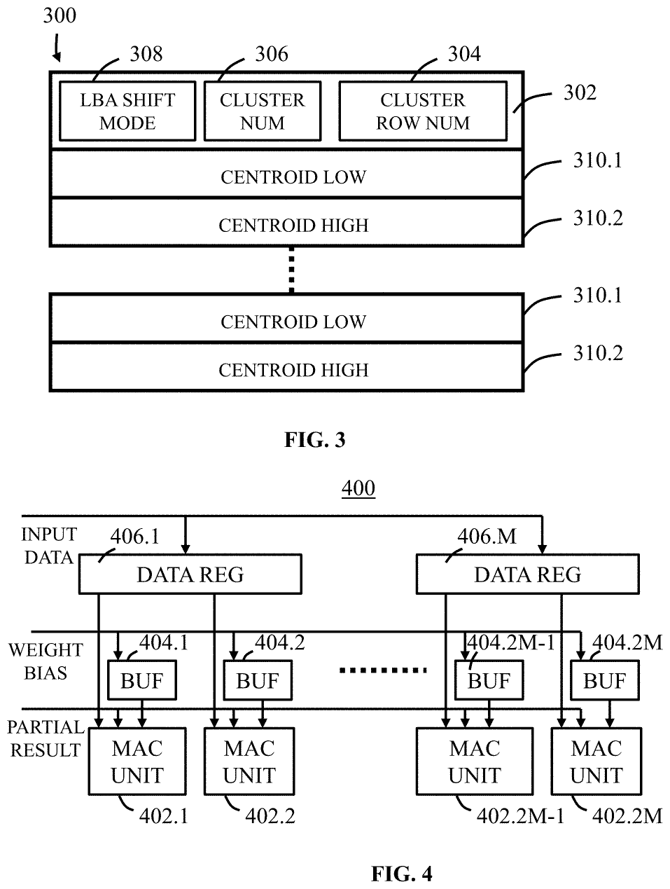

FIG. 2 schematically shows a K-Means layer 200 in accordance with an embodiment of the present disclosure. The K-Means layer 200 may be an embodiment of the K-Means layer 110, and may comprise a cluster classifier 202, an age calculator 204, a demultiplexer 208, a plurality of cluster buffers 206.1 through 206.N and a multiplexer 210. The K-Means layer 200 may perform computation tasks according to K-Means configurations. FIG. 3 schematically shows a K-Means configuration 300 for the K-Means layer 200 in accordance with an embodiment of the present disclosure.

The K-Means configuration 300 may have a first row 302 that may include settings for the K-Means operation. For example, the settings may include a first field 304 specifying the number of historical data points to be kept in each of the cluster buffers 206.1 to 206.N, a second field 306 for the number of clusters, and a third field 308 for data division of Least Significant Bits (LSBs) and another for Most Significant Bits (MSBs). Each of the cluster buffers 206.1 to 206.N may be configured to keep H historical data points, and the number H may be specified in the first field 304. Moreover, the number of cluster buffers in the K-Means layer 200 may be N, but the number of clusters for the computation task may be specified in the second field 306, which may be any number from 1 up to N.

Each cluster may have one centroid and bits for the centroid may be divided into two sections: one for the Least Significant Bits (LSBs) and another for Most Significant Bits (MSBs). The configuration 300 may further include centroid rows 310.1 and 310.2. Each centroid row 310.1 may contain LSBs of a centroid and each centroid row 310.2 may contain MSBs of a centroid. The number of centroid rows may be the number of clusters specified in the second field 306 multiplied by two. For example, if the number of clusters is 16, then the number of centroid rows may be 32 (e.g., 16 centroid rows 310.1 and 16 centroid rows 310.2). In the embodiment that the maximum N is 64 (e.g., 64 cluster buffers 206), the maximum number of the centroid rows may be 128.

In some embodiments, the bit width of a data field in a data input point is not exactly double of the bit width of a configuration row. Therefore, the bit position to divide the LSBs and MSBs need not to be in the center of the data field, and may be specified in the third field 308. The LSBs and MSBs may be padded with zeros in the centroid rows 310.1 and 310.2. For data input that may be LBAs, division of LSBs and MSBs may also be referred to as LBA shift mode and thus the third field 308 may also be referred to as the LBA shift mode field 308. An input LBA may be divided into LSBs and MSBs, and padded the same way as the centroids for the clusters. For example, in one embodiment, an LBA may have 40 bits, and a configuration row may have 32 bits. The LBA shift mode field 308 may specify which of the 40 bits may belong to LSBs and which of the 40 bits may belong to MSBs.

The cluster classifier 202 may receive input data and centroids, and determine which cluster buffer an input data point may sent to (e.g., by generating a control signal to the demultiplexer 208). For hot/code prediction, the input data may include an LBA, a length of blocks of data to be accessed, and a command index for the current data access command. The cluster classifier 202 may calculate distances to the centroids of the clusters for an input data point and assign the input data point to a cluster based on calculated distances (e.g., the cluster that the input data point has the shortest distance to its centroid).

The age calculator 204 may be configured to determine an age associated with the input LBA. For example, the age calculator 204 may keep records of previous accesses for different addresses and save the records in a temporary storage (e.g., a register or memory in the age calculator 204, not shown). The age calculator 204 may obtain a most recent access for the address in the input LBA and compute the age between current command and the most recent access. In one embodiment, the age may be an index difference between the current command and the most recent access for the same address. For example, the current command may be the 20^{th} command from the host (e.g., index being 20) and the age calculator 204 may find the 12^{th} command with same LBA address and compute the age as eight (8) (e.g., 20 minus 12). In another embodiment, the age may be the timing difference between the current command and the most recent command that has the same address.

Data points in the cluster buffers 206.1 to 206.N may include historical data points and the current data point just received. The number H may also be referred to as a depth of a cluster buffer. The multiplexer 210 may be used to output data points from the cluster buffers 206.1 through 206.N. The control signal sent by the cluster classifier 202 to the demultiplexer 208 may also be sent to the multiplexer 210 to select the cluster buffer to output the data points in the cluster buffer. In one embodiment, each output data point may include 5 elements: LBA MSB part, LBA LSB part, length, age and cluster index. And the data points output from the selected cluster buffer may be a matrix of H rows and 5 columns, with H being the depth of the cluster buffer and 5 elements for each data point.

FIG. 4 schematically shows a MAC layer 400 in accordance with an embodiment of the present disclosure. The MAC layer 400 may be an embodiment of the MAC layer 112 of the computing system 100. The MAC layer 400 may comprise a plurality of MAC units 402.1 through 402.2M. Each of the plurality of MAC units 402.1 through 402.2M may have a corresponding buffer 404.1 through 404.2M for weights and bias. In some embodiments, several MAC units may be grouped together to share one buffer for input data. For example, a pair of MAC units may be grouped together to share one set of data registers. As shown in FIG. 4, MAC units 402.1 and 402.2 may share the data register 406.1, and MAC units 402.2M-1 and 402.2M may share the data register 406.M.

Each of the MAC unit 402.1 through 402.2M may comprise circuitry to perform B number of multiplications in parallel, and addition of the multiplication results and a partial result. Each multiplication may be performed by multiplying an input data element from a data register 406 with a weight from the buffer 404. The addition result may be a final result or a partial result. If the addition result is a partial result, it may be fed back to add with multiplication results of a next round of multiplication until the final result may be obtained. In the first round of calculation, there is no partial result and the input to the MAC unit for the partial result may be set to zero. In one embodiment, the number B may be four, so that each of the MAC unit 402.1 through 402.2M may be configured to perform 4 multiplications on 4 pairs of inputs. That is, 4 input data elements from a data register 406 may be multiplied to 4 weights from a buffer 404, respectively, and the 4 multiplication results may be added together and with the partial result.

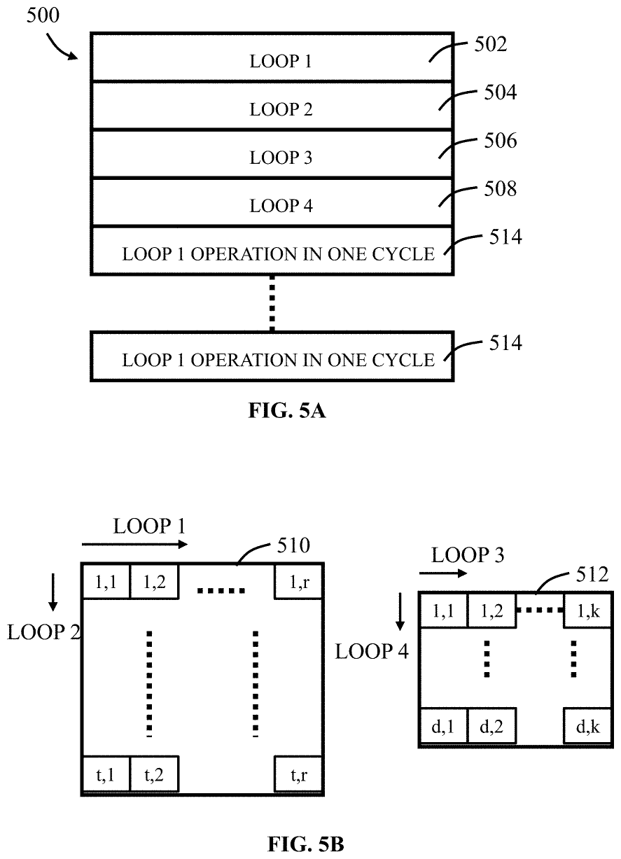

The MAC layer 400 may be used for performing MAC operations for a convolutional layer or a fully connected layer in a neural network according to configurations. The convolutional layer may also be referred to as a Convolutional Neural Network (CNN) layer and the fully-connected layer may also be referred to as a Fully-connected Neural Network (FNN) layer. FIG. 5A schematically shows a CNN configuration 500 for the MAC layer 400 to perform operations of a CNN layer in accordance with an embodiment of the present disclosure. The CNN layer computations may include using a weight matrix (also referred to as a kernel) to convolve around an input data matrix. FIG. 5B schematically shows a data input matrix 510 and a weight matrix 512 in accordance with an embodiment of the present disclosure.

The CNN configuration 500 may include a plurality of rows. Some rows may be used to describe the CNN operation topology and other rows may be used to describe operations in cycles. For example, the first 4 rows of the CNN configuration 500 may be used to describe the CNN operation topology. The first row 502 may describe the operation in the row direction of the input data matrix 510 (e.g., loop 1 direction in FIG. 5B), the second row 504 may describe the operation in the column direction of the input data matrix 510 (e.g., loop 2 direction in FIG. 5B), the third row 506 may describe the operation in the row direction of the weight matrix 512 (e.g., loop 3 direction in FIG. 5B), and the fourth row 508 may describe the operation in the column direction of the weight matrix 512 (e.g., loop 4 direction in FIG. 5B).

In general, the data input matrix 510 may have a size oft by r (e.g., t rows by r columns, with t and r being positive integers) and the weight matrix 512 may have a size of d by k (e.g., d rows by k columns, with d and k being positive integers). Because each MAC unit 402 of the MAC layer 400 may have limited multiplication and addition capability, a MAC unit may perform multiplication and addition on part of the weight matrix in each computation cycle. That is, it may take several cycles for one MAC unit 402 to generate one output data point. In an embodiment in which each MAC unit 402 may be configured to perform 4 multiplications, 4 input data elements of the data input matrix 510 and 4 weights of the weight matrix 512 may be multiplied by one MAC unit 402 in one computation cycle. The 4 input data elements of the data input matrix 510 may be from one row of the data input matrix 510 and the 4 weights of the weight matrix 512 may be from one row of the weight matrix 512.

The CNN operation topology may also include stride and padding, which may help determine how many loops may be needed in each of the loop 1 and loop 2 directions. As an example, when the stride is 1 and padding is zero, to complete a CNN layer operation on the data input matrix 510 and weight matrix 512, the loop 1 direction may need r−k+1 loops and the loop 2 direction may need t−d+1 loops. In at least one embodiment, the first row 502 may include fields that specify the number of loops in the loop 1 direction and the stride. The padding number may be derived from the number of loops in the loop 1 direction and thus not needed in the settings. In some embodiments, the calculation results of the CNN layer may be subjected to an activation function (e.g., sigmoid, tanh), and the first row 502 may also include a field to specify the activation function. The second row 504 may include fields that specify the number of loops in the loop 2 direction, data address offset for input data elements, partial result address offset for reading in the partial result from a previous cycle. It should be noted that when padding is not zero, the input data matrix 510 may be expanded in the row and column directions in the memory by adding elements of value zero. Thus, the input data elements to the MAC layer 400 may have padding elements.

The number of loops in the loop 3 and loop 4 directions may be determined based on the size of the weight matrix 512. For example, the loop 3 direction may need ceiling(k/4) loops and the loop 4 direction may need d loops. The ceiling function may be used to obtain a division result rounded up to the nearest whole number. The third row 506 may include fields that specify the number of loops in the loop 3 direction, data line offset for input data elements and weight address offset for next batch of weights in the row direction. As used herein, a batch of weights may refer to the set of weights loaded into a MAC unit in one cycle (e.g., 4 weights loaded into one MAC unit in a cycle). The fourth row 508 may include fields that specify the number of loops in the loop 4 direction, data address offset for input data elements and weight address offset for the next batch of weights in the column direction.

In one example, if the data input matrix 510 is 20 by 5 (e.g., t being 20 and r being 5) and the weight matrix 512 is 4 by 4 (e.g., d and k both being 4), with stride being 1 and padding being zero, the loop 1 direction may have two loops, the loop 2 direction may have 17 loops, the loop 3 direction may have 1 loop and the loop 4 direction may have 4 loops. And the output may be a 17 by 2 matrix. It should be noted that the CNN layer computation may also include adding a bias for each output data element, and then the data elements of the 17 by 2 matrix may be further processed by the activation function specified in the first row 502. In some embodiments, the row 508 may include a flag to indicate whether the bias needs to be added.

In another example, if the data input matrix 510 is 64 by 64 and the weight matrix 512 is 8 by 8, with stride being 1 and padding being zero, the loop 1 direction may have 57 loops, the loop 2 direction may have 57 loops, the loop 3 direction may have 2 loops and the loop 4 direction may have 8 loops. And the output may be a 57 by 57 matrix. A bias may be added to each data elements of the 57 by 57 matrix and the data elements may be further processed by the activation function specified in the first row 502.

After the first four rows, the CNN configuration 500 may include one or multiple rows 514 that specify the loop 1 operation cycle by cycle. In some embodiments, the two MAC units in one group may share the same batch of weights but have different input data elements, and the calculation results may be stored separately in a partial result buffer. For example, in one computation cycle, for input data, the MAC unit 402.1 may receive the first four elements of the first row of the data input matrix 510, the MAC unit 402.2 may receive the second through fifth elements of the first row of the data input matrix 510 (assuming the stride being 1 and padding being zero). For weights, both MAC unit 402.1 and 402.2 may both receive the 4 elements of the first row of the weight matrix 512.

In some embodiments, the same batch of weights may be reused to process the next batch of input data elements. For example, after the first four elements of the data input matrix 510 (e.g., in MAC unit 402.1) and the second through fifth elements of the data input matrix 510 (e.g., in MAC unit 402.2) are processed in the first computation cycle, the third through sixth elements of the first row of the data input matrix 510 may be received in the MAC unit 402.1 and the fourth through seventh elements of the first row of the data input matrix 510 may be received in the MAC unit 402.2, for the next computation cycle. The weights being multiplied in the next computation cycle may still be the first four elements of the first row of the weight matrix 512. It should be noted that because this approach may reuse already loaded weights in the MAC units, the computation process may be different from a conventional approach in which an output data point is finished before moving on to a next output.

In one embodiment, each row 514 may include fields that specify a list of settings including: whether weights are read in this cycle, whether input data needs to be read in this cycle, whether partial result data needs to be stored in this cycle, whether previous partial result data needs to be read in this cycle, the input data read address in the memory 104, an enable flag for the first MAC unit in a group, an enable flag for the second MAC unit in a group, where to store the partial result data and from where to read partial result data. In some embodiments, each input data register 406 may include a plurality of register units and the row 514 may also include a field specifying which data elements may be stored in which register units of the input data register 406.

It should be noted that a neural network may have multiple kernels in a CNN layer. These multiple kernels for a CNN layer may be referred to as multiple output channels. In one embodiment, each group of MAC units of the MAC layer 400 may be configured to perform convolution for one output channel. Therefore, in one embodiment, the MAC layer 400 may be configured to perform M output channels convolution in parallel. One CNN configuration 500 may be applied for one output channel. For the example data input matrix 510 being 20 by 5 and the weight matrix 512 being 4 by 4, the output may be 4 17 by 2 matrices if there are 4 kernels.

Moreover, sometimes the input data may have more than two dimensions. For example, image/video data may have three dimensions (e.g., color images in Red/Blue/Green commonly abbreviated as RGB or R/G/B). In these situations, respective CNN configuration 500 may be applied to each of the three colors of input data.

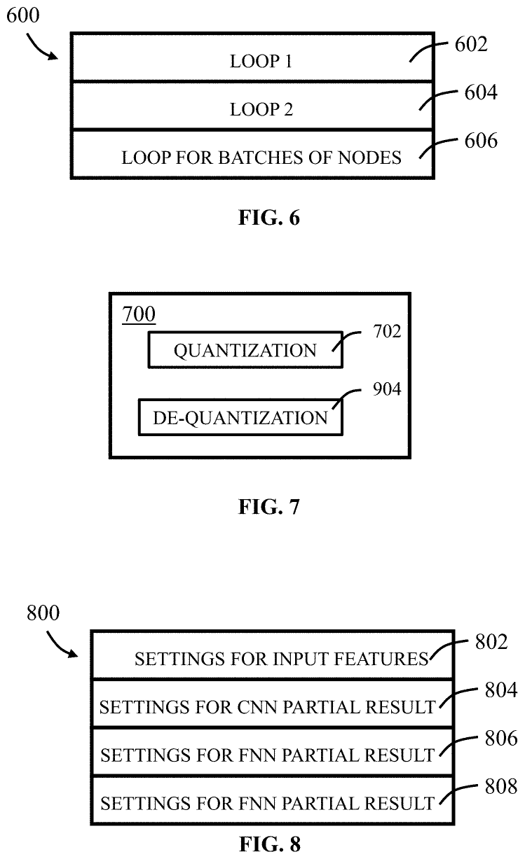

FIG. 6 schematically shows a FNN configuration 600 for the MAC layer 400 to perform operations of a FNN layer in accordance with an embodiment of the present disclosure. At the FNN layer, the weight matrix may have the same size as the data input matrix, and the FNN computations may include, at each node of the FNN layer, multiplying each data element of the input data matrix to a corresponding weight of a weight matrix and computing a summation of the multiplication results (and adding the bias if there is a bias). A FNN configuration may include several rows to describe the FNN operation topology. The data input matrix 510 of FIG. 5B may also be used as an example data input matrix for a FNN layer input. For example, the FNN configuration 600 may include 3 rows. The first row 602 may describe the operations in the row direction of the input data matrix and the weight matrix, the second row 604 may describe the operations in the column direction of the input data matrix and the weight matrix, and the third row 606 may describe the operations of the nodes of the FNN layer in batches based on the number of MAC units in the MAC layer 400.

In at least one embodiment, the first row 602 may include fields that specify the number of loops in the row direction of the input data matrix and an input buffer width. The input data to a FNN layer may come from the CNN output if the FNN layer is the first FNN layer in a neural network or from a first FNN layer if the FNN layer is the second FNN layer in a neural network. The CNN result buffer may have a buffer width different from the FNN result buffer. For example, CNN result buffer width may be 16 and the FNN result buffer width may be 8. The input buffer width parameter may help the MAC layer 400 to decide how to read data from input buffers with different buffer widths. For example, if the input buffer width is 16 and the number of loops in the row direction of the input data matrix is 64. The MAC layer 400 may need to jump to next address to read data per 16 input data points.

In some embodiments, the calculation results of the FNN layer may be subjected to an activation function (e.g., sigmoid, tanh), and the first row 602 may also include a field to specify the activation function. The second row 604 may have fields that specify the number of loops in the column direction of the input data matrix and data address offset for input data elements. The third row 606 may include fields that specify the number of loops for batches of nodes and weight address offset for the next batch of weights. The number of loops in the third row 606 may be determined based on the number of nodes of the FNN layer and how many MAC units in the MAC layer 400. For example, for an embodiment in which the MAC layer 400 has 8 MAC units 402 (e.g., M being 4), the number of loops or batches of nodes may be ceiling(total number of nodes of the FNN layer divided by 8).

In an example, the input to a FNN layer may be a four channel 17 by 2 matrix (e.g., 4×17×2), the FNN layer may have 32 nodes, and the MAC layer 400 may have 8 MAC units 402. The first row of the input matrices may have a total of 8 data elements (each matrix has 2 elements in the first row and there are 4 matrices). In an embodiment in which each MAC unit 402 is configured to perform 4 multiplications in parallel, the first row 602 may have a loop number of 2 (8 data elements need two loops to process), the second row 604 may have a loop number of 17 and the third row 606 may have a loop number of 4 (e.g., ceiling(32/8)).

Sometimes, a neural network may have more than one FNN layer. For example, the output from the above example of 32 nodes FNN layer (e.g., after bias is added and activation function is applied if needed) may be input to another FNN layer with 8 nodes. The output from the 32 nodes FNN layer may be stored in 4 buffers each having 4(row)×2(column) data. For the MAC layer 400 to perform operations of the second FNN layer, the first row 602 may have a loop number of 2, the second row 604 may have a loop number of 4 and the third row 606 may have a loop number of 1.

FIG. 7 schematically shows a quantization layer 700 in accordance with an embodiment of the present disclosure. The quantization layer 700 may be an embodiment of the quantization layer 114 of the computing system 100. The quantization layer 700 may comprise a quantization unit 702 and a de-quantization unit 704. Data elements in a neural network may have different bit width and precision at different stages of computation. The quantization layer 700 may invoke several quantization related functions and may transfer input values from real numbers to quantized numbers using the quantization unit 702 and from quantized numbers to real numbers using a de-quantization unit 704.

The quantization layer 700 may be used for preparing the data elements for a next stage of computation based on needs. For example, a 32-bit real number may be transferred to an 8-bit integer according to a scaling factor and a zero point. The scaling factor may be the ratio from original value range to quantized value range and the zero point may be the quantized point of original value 0. The zero points and scaling factors may be derived from the neural network training result (e.g., training using a computer program in a high-level programming language such as Python).

In some embodiments, the quantization layer 700 may have two modes of operation: a direct mode and a configuration mode. In the direct mode, the quantization layer 700 may be driven directly by another hardware computational layer. For example, the quantization layer 700 may be driven directly by the K-Means layer 200. In the direct mode, the calculation results of the K-Means layer 110 may be processed by the quantization layer 700 before being used as input to a next computational layer.

In the configuration mode, the quantization layer 700 may perform operations according to a quantization configuration. FIG. 8 schematically shows a quantization configuration 800 for the quantization layer 700 in accordance with an embodiment of the present disclosure. The quantization configuration 800 may have several fixed rows to describe the operations to be performed by the quantization layer 700. As an example, the quantization configuration 800 may have 4 rows. Row 802 may be configuration settings when the input to the quantization layer 700 may be an input feature buffer for a neural network. In one embodiment, data elements of the input feature may be quantized but there is no activation function applied so row 802 may contain fields that specify the number of rows and columns of the input data matrix in the input feature buffer that quantization may be applied.

Row 804 may be configuration settings when the input to the quantization layer 700 may be from the CNN partial result buffer. Activation function may be applied to CNN calculation results, so row 804 may contain fields that specify the location of data elements in the CNN partial result buffer for which quantization may be applied, and the activation function (e.g., none, sigmoid, tanh, ReLU, etc.).

Row 806 may be configuration settings when the input to the quantization layer 700 may be from a FNN partial result buffer. Row 808 may be configuration settings when the input to the quantization layer 700 may be from another FNN partial result buffer (for a second FNN layer of a neural network that has more than one FNN layer). Activation function may be applied to FNN calculation results, so both row 806 and row 808 may contain fields that specify the location of data elements in the FNN partial result buffer (e.g., row number and column number in the buffer) for which the quantization may be applied, and the activation function (e.g., none, sigmoid, tanh, ReLU, etc.).

In one embodiment, the quantization layer 700 may perform four different types of data transformation. The first type may be transforming input real values to quantized values. For example, in a direct mode, transforming K-Means output, or in a configuration mode, transforming input feature in the input feature buffer. The second type may be transforming pooling result quantized values to quantized values in a direct mode. The third type may be transforming MAC layer partial result quantized values to real values in a configuration mode. The fourth type may be applying an activation function to transform a MAC layer accumulation sum to a quantized value (e.g., either in a direct mode or in a configuration mode).

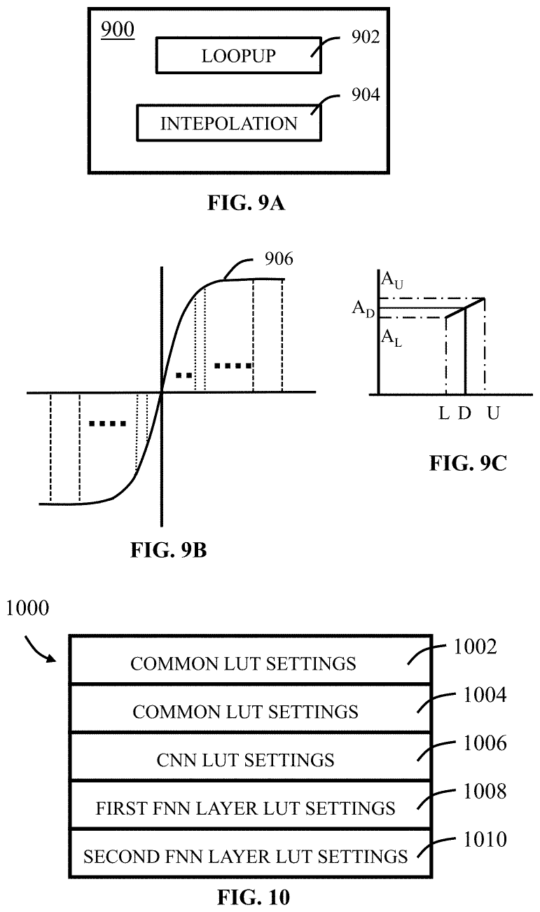

FIG. 9A schematically shows a lookup table (LUT) layer 900 in accordance with an embodiment of the present disclosure. The LUT layer 900 may be an embodiment of the LUT layer 116 of the computing system 100. The LUT layer 900 may include a lookup unit 902 and an interpolation unit 904. The lookup unit 902 may take an input value and find a segment (e.g., an upper value and a lower value) that encloses the input value. The interpolation unit 904 may perform an interpolation to generate a more precise result based on the upper value and lower value. It should be noted that the LUT layer 900 may include a plurality of lookup units and corresponding interpolation units. The number of lookup units may be a hyperparameter which may depend on the hardware design.

FIG. 9B schematically shows segmentation of an activation function curve 906 in accordance with an embodiment of the present disclosure. Some activation functions (e.g., ReLU, tanh, and sigmoid) may have different slopes in different sections of its activation function curve. For example, the activation function curve 906 may have a steep slope (e.g., a high slope) in a segment denoted by dotted lines and a much slower slope (e.g., a low slope) in a segment denoted by dashed lines. In some embodiments, segments for an activation function may have different widths. For example, segments covering high slopes of the activation function curve 906 may have shorter widths and segments covering low slopes of the activation function curve 906 may have bigger widths. Moreover, in one embodiment, the data points for segments of the high slopes may be saved in one table and the data points for segments of the low slopes may be stored in another table. And the lookup unit 902 may be configured to search the tables according to settings in a LUT configuration.

FIG. 9C schematically shows an interpolation for an input data point in accordance with an embodiment of the present disclosure. The input data point denoted as “D” in FIG. 9C may be enclosed by a segment with a lower value of “L” and an upper value of “U.” The output of the activation function for the input data point “D” (denoted as A_{D}) may be calculated by a linear interpolation based on the activation function values A_{L} and A_{U} of the lower value “L” and higher value “U” as A_{D}=((D−L)*(A_{U}−A_{L}))/(U−L))+A_{L}, with “*” being the multiplication operator, “/” being the division operator.

FIG. 10 schematically shows a LUT configuration 1000 for the lookup table layer 900 in accordance with an embodiment of the present disclosure. The row number of the LUT configuration 1000 may be fixed. In one embodiment, two rows may be used for common settings of the lookup table layer 900. For example, the common settings in row 1002 and row 1004 may include, but not limited to: the start point of low slope range, the end point of low slope range, the length of slow slope range (e.g., log 2 of the length), the start point of high slope range, the end point of high slope range, the length of high slope range (e.g., log 2 of the length), the highest bound of the LUT range (e.g., for tanh & sigmoid fixed as 1 or “close” to 1; but for other activation function, not necessarily close to 1). After the common settings, there may be one row in the LUT configuration 1000 for CNN settings and two rows for FNN settings. For example, row 1006 may include settings for CNN operations, row 1008 may include settings for the MAC layer as a first FNN layer and row 1010 may include settings for the MAC layer as a second FNN layer. For CNN and FNN LUT settings, each of the rows 1006, 1008 and 1010 may contain fields that specify the location of data elements in the data buffer (e.g., input feature buffer, CNN result buffer or FNN result buffer) for which lookup may be performed, and the activation function (e.g., none, sigmoid, tanh, ReLU, etc.).

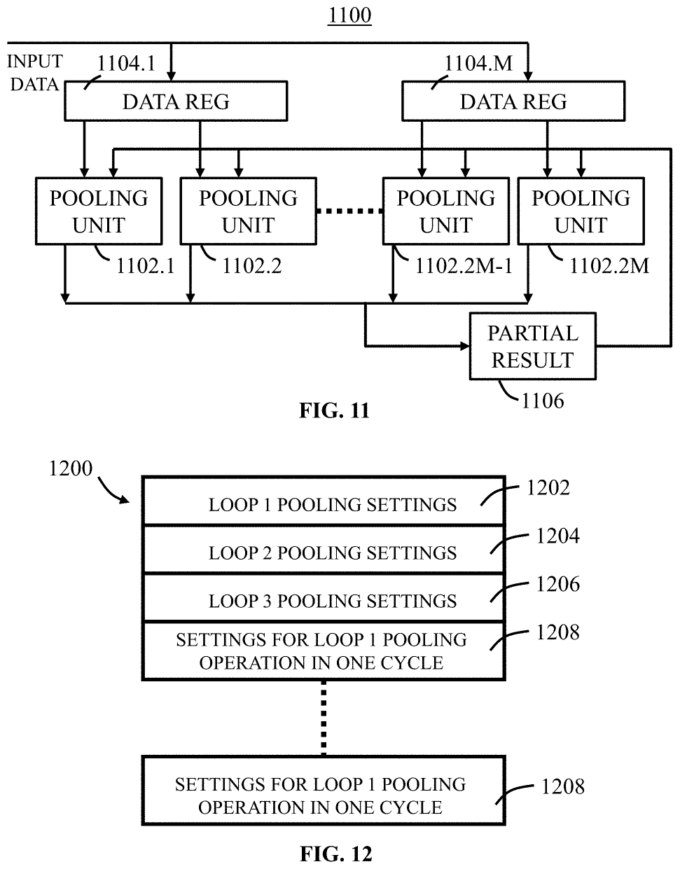

FIG. 11 schematically shows a pooling layer 1100 in accordance with an embodiment of the present disclosure. The pooling layer 1100 may be an embodiment of the pooling layer 118 of the computing system 100. The pooling layer 1100 may comprise a plurality of pooling units 1102.1 through 1102.2M. In some embodiments, several pooling units may be grouped together to share one buffer for input data. For example, a pair of pooling units may be grouped together to share one set of data registers. As shown in FIG. 11, pooling units 1102.1 and 1102.2 may share the data register 1104.1, and pooling units 1102.2M-1 and 1102.2M may share the data register 1104.M. In one embodiment, the number M for the pooling units 1102.1 through 1102.2M may be the same as the number M of channels for the MAC layer 400. But this is optional.

Each of the pooling unit 1102.1 through 1104.2M may comprise circuitry to perform comparisons on multiple inputs. For example, 4 data inputs from a data register 1104 and a partial result input from a pooling partial result buffer 1106 may be compared in a pooling unit to obtain a maximum for max-pooling (or a minimum for a min-pooling). The maximum or the minimum may be a final result or a partial result. If the comparison result is a partial result, it may be stored to the pooling partial result buffer 1106 and then fed back to compare with a next round of input data elements until the final result may be obtained. In the first round of calculation, there may be only four input data elements without any partial result.

The pooling layer 1100 may be used for performing pooling operations in a neural network according to configurations. FIG. 12 schematically shows a pooling configuration 1200 for the pooling layer 1100 to perform pooling operations in accordance with an embodiment of the present disclosure. The first several rows may be fixed and used to describe the pooling operation topology and succeeding rows may describe the operations of pooling units cycle by cycle. Number of succeeding rows may vary based on the dimension of input matrix and parameters of pooling.

In the embodiment shown in FIG. 12, the first 3 rows may be fixed. The data input matrix 510 of FIG. 5B may also be used as an example data input matrix for the pooling layer 1100. The first row 1202 of the pooling configuration 1200 may describe the operation in the column shift direction of the input data matrix (e.g., loop 1 direction of matrix 510 in FIG. 5B), the second row 1204 may describe the operation in the row shift direction of pooling kernel, the third row 1206 may describe the pooling unit operation along the input data column shift direction (e.g., loop 2 direction of matrix 510 in FIG. 5B). Because each pooling unit 1102 of the pooling layer 1100 may have limited inputs, it may take several cycles for one pooling unit 1102 to generate one output data point. For example, for a pooling operation with a pooling kernel of 4 by 4, it may take 4 pooling computation cycle to generate one output data point when each pooling unit is configured to do comparison on 4 data input elements and a partial result.

In one embodiment, the row 1202 may include fields that specify several settings including: the number of pooling unit shifts along the input matrix in the row direction (from one batch of columns to the next batch of columns), the stride of pooling kernel shift, and whether it is max-pooling or min-pooling. The pooling operation topology may include stride and padding, and this information may help determine how many loops may be needed. For example, with the stride and padding information, the number of pooling unit shifts along the input matrix in the row direction may be determined by the equation of

$$ceiling ( ( \frac{COL\_SIZE + PADDING - KERNEL\_SIZE}{STRIDE} + 1 ) / 2 ) ,$$

in which COL_SIZE is the number of columns in the input data matrix, KERNEL_SIZE is the number of columns in the kernel. With the number of pooling unit shifts in the row 1202, the padding number may be derived and not included in the settings.

The second row 1204 of the pooling configuration 1200 may be used to describe shifting of pooling kernel from one row to a next row, and may include fields that specify several settings including: the number of rows of the pooling kernel, the address offset for next batch of data input in the memory.

The third row 1206 of the pooling configuration 1200 may be used to describe the pooling unit operation for the input data from one row to a next row. Fields in the third row 1206 may include settings that specify: the number of pooling unit shifts along the input matrix in the column direction, the data address offset of next batch of data input in the memory, the address offset of stored partial result data, an upper boundary of memory address for input data (e.g., data stored beyond this point will not be processed by the pooling layer). In one embodiment, the number of pooling unit shifts along the input matrix in the column direction may be determined by the equation of

$$ceiling ( ( \frac{ROW\_SIZE + PADDING - KERNEL\_SIZE}{STRIDE} + 1 ) ) ,$$

in which ROW SIZE is the number of rows in the input data matrix.

After the first three rows, the pooling configuration 1200 may include one or multiple rows 1208 that specify the loop 1 pooling operations cycle by cycle. In one embodiment, two pooling units 1102 may be grouped for one channel and there may be M channels. The two pooling units may have two separate batch of input data elements and store the partial result data separately. In one embodiment, each row 1208 may include fields that specify a list of settings including: whether input data needs to be read in this cycle, whether partial result data needs to be stored in this cycle, whether previous partial result data needs to be read in this cycle, the input data read address in the memory 104, an enable flag for the first pooling unit in a group, an enable flag for the second pooling unit in a group, where to store the partial result data and from where to read partial result data. In some embodiments, each input data register 1104 may include a plurality of register units and the row 1208 may also include a field specifying which data elements may be stored in which register units of the input data register 1104.

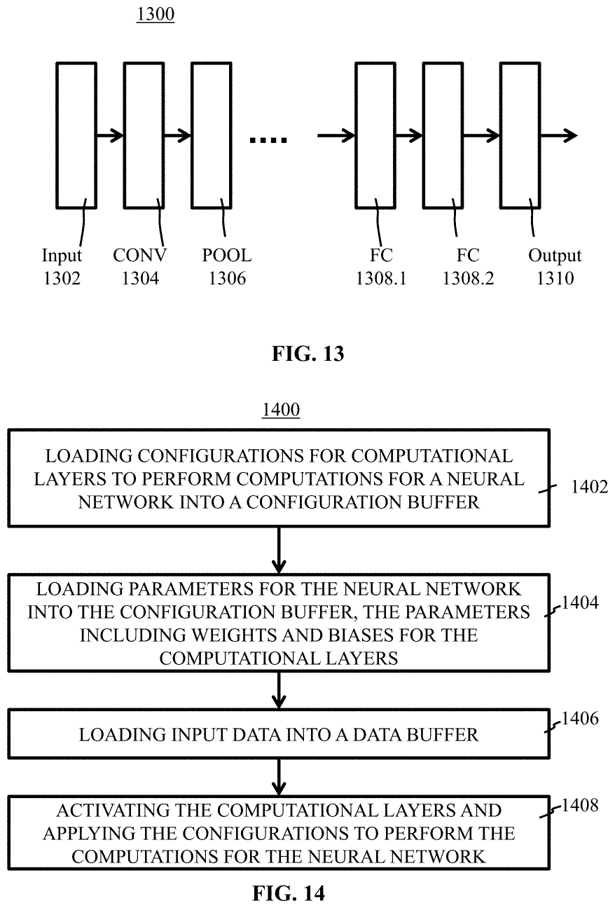

FIG. 13 schematically shows a neural network 1300 in accordance with an embodiment of the present disclosure. The neural network 1300 may comprise many layers of connected units or nodes called artificial neurons, which loosely model neurons in a biological brain. In one example, the neural network 1300 may comprise an input layer 1302, a convolutional layer 1304 followed by a pooling layer 1306. The input layer 1302 may comprise neurons configured to receive input signals, which may be referred to as input features. A typical neural network may include more than one convolutional layer 1304 with each CNN layer followed by a pooling layer 1306. Outputs from each convolutional layer 1304 may be applied an activation function (e.g., sigmoid, tanh, ReLU, etc.) and then passed to the pooling layer 1306. These convolutional layers and pooling layers may be used, for example, for feature learning in image processing neural networks. After the one or more convolutional layers 1304 and corresponding pooling layer 1306, the network 1300 may further include a first fully connected layer 1308.1, a second fully connected layer 1308.2, and an output layer 1310. A typical neural network may include one or more FNN layers and the network 1300 shows two FNN layers as an example. The output layer 1310 may comprise one or more neurons to output a signal based on input conditions. In some embodiments, a signal at a connection between two neurons may be a real number or a quantized integer.

As an example, the neural network 1300 may be a neural network for hot/cold prediction with the neural network computations performed by the AI engine 106, the input layer 1302 may comprise a plurality of neurons to receive input features that include the address, length, age of a current command, and addresses, lengths, ages of a plurality of historical commands. The input features may be the output from the K-Means layer 110 according to a K-Means configuration 300 and processed by the quantization layer 114 according to a quantization configuration 800. The input features may be processed by one or more CNN layers 1304 and pooling layers 1306, and one or more FNN layers 1308. The MAC layer 112 may be configured to perform the CNN layers' computations based on respective CNN configurations 500 for the one or more CNN layers and perform FNN layers' computations based on respective FNN configurations 600 for the one or more FNN layers. The calculation results of the MAC layer 112 may be further processed by the quantization layer 114, the LUT layer 116, or both. The output layer 1310 may include one neuron to output a label that may indicate whether data associated with the current data access command is hot or cold.

As another example, the neural network 1300 may be a neural network for image processing with computations performed by the AI engine 106. K-Means layer 110 may not be needed for an image processing neural network. The input layer 1302 may comprise a plurality of neurons to receive input features that include the one or more images or videos (which may be color coded, such as RGB). The CNN layer 1304 and pooling layer 1306 may perform feature extraction. The FNN layers 1308 and the output layer 1310 may perform final classification of input image (e.g., whether the image contains dog or cat, etc.) The MAC layer 112 may be configured to perform the CNN layers' computations and FNN layers' computations based on respective CNN configurations 500 for the one or more CNN layers and respective FNN configurations 600 for the one or more FNN layers. The calculation results of the MAC layer 112 may be further processed by the quantization layer 114, the LUT layer 116, or both. The output layer 1306 may comprise one or more neurons to output computation results (e.g., whether the input image(s) may contain a dog, cat, person, etc.).

FIG. 14 is a flowchart of a process 1400 for the AI engine 106 to perform a neural network computation in accordance with an embodiment of the present disclosure. At block 1402, configurations for computational layers to perform computations for a neural network may be loaded into a configuration buffer. The computational layers may include a multiply-accumulate (MAC) layer (e.g., the MAC layer 112) and the configurations may include at least one fully-connected neural network (FNN) configuration (e.g., a FNN configuration 600) for the MAC layer to perform computations for at least one FNN layer.

At block 1404, parameters for the neural network may be loaded into the data buffer. The parameters may include weights and biases for the computational layers. For example, the parameters may be generated by pre-training the neural network and loaded into the data buffer 122 at run time. At block 1406, input data may be loaded into a data buffer. For example, the input data may be image/video for image processing, and data access command (e.g., read or write) and for hot/cold prediction. The input data may be loaded into the data buffer 122 at run time.

At block 1408, the computational layers may be activated and the configurations may be applied to the computational layers to perform the computations for the neural network. This may include applying the at least one FNN configuration to the MAC layer to perform the computations for the at least one FNN layer. The MAC layer may include a plurality of MAC units. The at least one CNN configuration may include settings for a CNN operation topology and settings for cycle-by-cycle operations for the plurality of MAC units to perform the computations for the at least one CNN layer. The at least one FNN configuration may include settings for a FNN operation topology for the plurality of MAC units to perform the computations for the at least one FNN layer.

In an exemplary embodiment, there is provided an apparatus that may comprise a controller, a configuration buffer, a data buffer and a plurality of computational layers including a multiply-accumulate (MAC) layer that includes a plurality of MAC units. The controller may be configured to dispatch computing tasks of a neural network and configured to: load configurations for the plurality of computational layers to perform computations for the neural network into the configuration buffer, load parameters for the neural network into the data buffer and load input data into the data buffer. The configurations may include at least one fully-connected neural network (FNN) configuration for the MAC layer to perform computations for at least one FNN layer. The parameters may include weights and biases for the plurality of computational layers. The MAC layer may be configured to apply the at least one FNN configuration to perform the computations for the at least one FNN layer. The at least one FNN configuration may include settings for a FNN operation topology for the plurality of MAC units to perform the computations for the at least one FNN layer.

In an embodiment, the configurations may further include at least one convolutional neural network (CNN) configuration for the MAC layer to perform computations for at least one CNN layer. The at least one CNN configuration may include settings for a CNN operation topology and settings for cycle-by-cycle operations for the plurality of MAC units to perform the computations for the at least one CNN layer. The settings for the CNN operation topology may include settings for operations in a row direction of an input data matrix, settings for operations in a column direction of the input data matrix, settings for operations in a row direction of a weight matrix and settings for operations in a column direction of the weight matrix.

In an embodiment, the plurality of MAC units may be grouped into several groups. Each group may include one or more MAC units and may be configured to perform convolutions for one output channel according to the at least one CNN configuration, the one or more MAC units in one group may share a same batch of weights but have different input data elements.

In an embodiment, the settings for the FNN operation topology may include settings for operations in a row direction of an input data matrix and a weight matrix, settings for operations in a column direction of the input data matrix and the weight matrix, and settings for operations of nodes of the at least one FNN layer in batches based on a number of MAC units in the MAC layer.

In an embodiment, the plurality of computational layers may further include a K-Means layer configured to cluster the input data into a plurality of clusters according to a K-Means configuration.

In an embodiment, the plurality of computational layers may further include a quantization layer configured to transform data values from real numbers to quantized numbers and from quantized numbers to real numbers.

In an embodiment, the quantization layer may be configured to perform data transformation driven by another computational layer.

In an embodiment, the quantization layer may be configured to perform data transformation according to a quantization configuration.

In an embodiment, the plurality of computational layers may further include a pooling layer that includes a plurality of pooling units each configured to compare multiple input values. The pooling layer may be configured to perform a max-pooling or a min-pooling according to a pooling configuration that may include settings for a pooling operation topology and settings for cycle-by-cycle operations for the plurality of pooling units.

In an embodiment, the plurality of computational layers may further include a lookup table layer configured to generate an output value for an activation function by looking up a segment of an activation function curve enclosing an input data value and performing an interpolation based on activation function values for an upper value and a lower value of the segment.

In another exemplary embodiment, there is provided a method comprising: loading configurations for computational layers to perform computations for a neural network into a configuration buffer, loading parameters for the neural network into a data buffer, loading input data into the data buffer and activating the computational layers and applying the configurations to perform the computations for the neural network. The computational layers may include a multiply-accumulate (MAC) layer. The configurations may include at least one fully-connected neural network (FNN) configuration for the MAC layer to perform computations for at least one FNN layer. The parameters may include weights and biases for the computational layers. Activating the computational layers and applying the configurations may include applying the at least one FNN configuration to the MAC layer. The MAC layer may include a plurality of MAC units. The at least one FNN configuration may include settings for a FNN operation topology for the plurality of MAC units to perform the computations for the at least one FNN layer.

In an embodiment, the configurations may further include at least one convolutional neural network (CNN) configuration for the MAC layer to perform computations for at least one CNN layer, and activating the computational layers and applying the configurations to perform the computations for the neural network may further include applying the at least one CNN configuration to the MAC layer. The at least one CNN configuration may include settings for a CNN operation topology and settings for cycle-by-cycle operations for the plurality of MAC units to perform the computations for the at least one CNN layer. The settings for the CNN operation topology may include settings for operations in a row direction of an input data matrix, settings for operations in a column direction of the input data matrix, and settings for operations in a row direction of a weight matrix and settings for operations in a column direction of the weight matrix.

In an embodiment, the plurality of MAC units may be grouped into several groups. Each group may include one or more MAC units and may be configured to perform convolutions for one output channel according to the at least one CNN configuration. The one or more MAC units in one group may share a same batch of weights but have different input data elements.

In an embodiment, the settings for the FNN operation topology may include settings for operations in a row direction of an input data matrix and a weight matrix, settings for operations in a column direction of the input data matrix and the weight matrix, and settings for operations of nodes of the at least one FNN layer in batches based on a number of MAC units in the MAC layer.

In an embodiment, the method may further comprise clustering the input data into a plurality of clusters according to a K-Means configuration using a K-Means layer of the plurality of computational layers.

In an embodiment, the method may further comprise transforming data values from real numbers to quantized numbers and from quantized numbers to real numbers using a quantization layer of the plurality of computational layers.

In an embodiment, the quantization layer may be configured to perform data transformation driven by another computational layer.

In an embodiment, the quantization layer may be configured to perform data transformation according to a quantization configuration.

In an embodiment, the method may further comprise performing a max-pooling or a min-pooling according to a pooling configuration using a pooling layer of the plurality of computational layers. The pooling layer may include a plurality of pooling units each configured to compare multiple input values. The pooling configuration may include settings for a pooling operation topology and settings for cycle-by-cycle operations for the plurality of pooling units.

In an embodiment, the method may further comprise generating an output value for an activation function using a lookup table layer of the plurality of computational layers. The lookup table layer may be configured to look up a segment of an activation function curve enclosing an input data value and perform an interpolation based on activation function values for an upper value and a lower value of the segment.

Any of the disclosed methods and operations may be implemented as computer-executable instructions (e.g., software code for the operations described herein) stored on one or more computer-readable storage media (e.g., non-transitory computer-readable media, such as one or more optical media discs, volatile memory components (such as DRAM or SRAM), or nonvolatile memory components (such as hard drives)) and executed on a device controller (e.g., firmware executed by ASIC). Any of the computer-executable instructions for implementing the disclosed techniques as well as any data created and used during implementation of the disclosed embodiments can be stored on one or more computer-readable media (e.g., non-transitory computer-readable media).

As used herein, a non-volatile memory device may be a computer storage device that can maintain stored information after being powered off, and the stored information may be retrieved after being power cycled (turned off and back on). Non-volatile storage devices may include floppy disks, hard drives, magnetic tapes, optical discs, NAND flash memories, NOR flash memories, Magnetoresistive Random Access Memory (MRAM), Resistive Random Access Memory (RRAM), Phase Change Random Access Memory (PCRAM), Nano-RAM, etc. In the description, a NAND flash may be used an example for the proposed techniques. However, various embodiments according to the present disclosure may implement the techniques with other kinds of non-volatile storage devices.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An apparatus, comprising:
a controller configured to dispatch computing tasks of a neural network;
a configuration buffer;
a data buffer; and
a plurality of computational layers including a multiply-accumulate (MAC) layer that includes a plurality of MAC units,
wherein the controller is configured to:
load configurations for the plurality of computational layers to perform computations for the neural network into the configuration buffer, the configurations including at least one fully-connected neural network (FNN) configuration for the MAC layer to perform computations for at least one FNN layer;
load parameters for the neural network into the data buffer, the parameters including weights and biases for the plurality of computational layers; and
load input data into the data buffer;
wherein the MAC layer is configured to:
apply the at least one FNN configuration to perform the computations for the at least one FNN layer, the at least one FNN configuration including settings for a FNN operation topology for the plurality of MAC units to perform the computations for the at least one FNN layer.

2. The apparatus of claim 1, wherein the configurations further include at least one convolutional neural network (CNN) configuration for the MAC layer to perform computations for at least one CNN layer, the at least one CNN configuration includes settings for a CNN operation topology and settings for cycle-by-cycle operations for the plurality of MAC units to perform the computations for the at least one CNN layer, and the settings for the CNN operation topology include settings for operations in a row direction of an input data matrix, settings for operations in a column direction of the input data matrix, settings for operations in a row direction of a weight matrix and settings for operations in a column direction of the weight matrix.

3. The apparatus of claim 2, wherein the plurality of MAC units are grouped into several groups, and each group includes one or more MAC units and is configured to perform convolutions for one output channel according to the at least one CNN configuration, the one or more MAC units in one group share a same batch of weights but have different input data elements.

4. The apparatus of claim 1, wherein the settings for the FNN operation topology include settings for operations in a row direction of an input data matrix and a weight matrix, settings for operations in a column direction of the input data matrix and the weight matrix, and settings for operations of nodes of the at least one FNN layer in batches based on a number of MAC units in the MAC layer.

5. The apparatus of claim 1, wherein the plurality of computational layers further include a K-Means layer configured to cluster the input data into a plurality of clusters according to a K-Means configuration.

6. The apparatus of claim 1, wherein the plurality of computational layers further include a quantization layer configured to transform data values from real numbers to quantized numbers and from quantized numbers to real numbers.

7. The apparatus of claim 6, wherein the quantization layer is configured to perform data transformation driven by another computational layer.

8. The apparatus of claim 6, wherein the quantization layer is configured to perform data transformation according to a quantization configuration.

9. The apparatus of claim 1, wherein the plurality of computational layers further include a pooling layer that includes a plurality of pooling units each configured to compare multiple input values, the pooling layer is configured to perform a max-pooling or a min-pooling according to a pooling configuration that includes settings for a pooling operation topology and settings for cycle-by-cycle operations for the plurality of pooling units.

10. The apparatus of claim 1, wherein the plurality of computational layers further include a lookup table layer configured to generate an output value for an activation function by looking up a segment of an activation function curve enclosing an input data value and performing an interpolation based on activation function values for an upper value and a lower value of the segment.

11. A method, comprising:
loading configurations for computational layers to perform computations for a neural network into a configuration buffer, the computational layers including a multiply-accumulate (MAC) layer, and the configurations including at least one fully-connected neural network (FNN) configuration for the MAC layer to perform computations for at least one FNN layer;
loading parameters for the neural network into a data buffer, the parameters including weights and biases for the computational layers;
loading input data into the data buffer; and
activating the computational layers and applying the configurations to perform the computations for the neural network, including: applying the at least one FNN configuration to the MAC layer, the MAC layer including a plurality of MAC units, the at least one FNN configuration including settings for a FNN operation topology for the plurality of MAC units to perform the computations for the at least one FNN layer.

12. The method of claim 11, wherein the configurations include at least one convolutional neural network (CNN) configuration for the MAC layer to perform computations for at least one CNN layer, and activating the computational layers and applying the configurations to perform the computations for the neural network further include applying the at least one CNN configuration to the MAC layer, wherein the at least one CNN configuration including settings for a CNN operation topology and settings for cycle-by-cycle operations for the plurality of MAC units to perform the computations for the at least one CNN layer, the settings for the CNN operation topology include settings for operations in a row direction of an input data matrix, settings for operations in a column direction of the input data matrix, and settings for operations in a row direction of a weight matrix and settings for operations in a column direction of the weight matrix.

13. The method of claim 12, wherein the plurality of MAC units are grouped into several groups, and wherein each group includes one or more MAC units and is configured to perform convolutions for one output channel according to one CNN configuration, the one or more MAC units in one group share a same batch of weights but have different input data elements.

14. The method of claim 11, wherein the settings for the FNN operation topology include settings for operations in a row direction of an input data matrix and a weight matrix, settings for operations in a column direction of the input data matrix and the weight matrix, and settings for operations of nodes of the at least one FNN layer in batches based on a number of MAC units in the MAC layer.

15. The method of claim 11, further comprising clustering the input data into a plurality of clusters according to a K-Means configuration using a K-Means layer of the plurality of computational layers.

16. The method of claim 11, further comprising transforming data values from real numbers to quantized numbers and from quantized numbers to real numbers using a quantization layer of the plurality of computational layers.

17. The method of claim 16, wherein the quantization layer is configured to perform data transformation driven by another computational layer.

18. The method of claim 16, wherein the quantization layer is configured to perform data transformation according to a quantization configuration.

19. The method of claim 11, further comprising performing a max-pooling or a min-pooling according to a pooling configuration using a pooling layer of the plurality of computational layers, wherein the pooling layer includes a plurality of pooling units each configured to compare multiple input values, and the pooling configuration includes settings for a pooling operation topology and settings for cycle-by-cycle operations for the plurality of pooling units.

20. The method of claim 11, further comprising generating an output value for an activation function using a lookup table layer of the plurality of computational layers, wherein the lookup table layer is configured to look up a segment of an activation function curve enclosing an input data value and perform an interpolation based on activation function values for an upper value and a lower value of the segment.
